(19) United States
(12) Patent Application Publication
(10) Pub. No.: US 2013/0175776 A1
(43) Pub. Date: Jul. 11, 2013

(54) APPARATUS FOR ADJUSTING CAMBER AND/OR TOE OF WHEELS OF SUSPENSIONS

(71) Applicants: Wilfried Michel, Riedenburg (DE); Karl-Heinz Meitinger, Munich (DE); Christoph Kossira, Ingolstadt (DE); Hugo Müller, Rohrenfels-Ballersdorf (DE); Wolfgang Schmid, Freising (DE)

(72) Inventors: Wilfried Michel, Riedenburg (DE); Karl-Heinz Meitinger, Munich (DE); Christoph Kossira, Ingolstadt (DE); Hugo Müller, Rohrenfels-Ballersdorf (DE); Wolfgang Schmid, Freising (DE)

(73) Assignee: AUDI AG, Ingolstadt (DE)

(21) Appl. No.: 13/516,434

(22) PCT Filed: Dec. 8, 2010
(86) PCT No.: PCT/EP2010/007444

§ 371 Date: Aug. 7, 2012

(30) Foreign Application Priority Data
Dec. 16, 2009 (DE) 102009058490.0

(51) Int. Cl. B62D 17/00

(52) U.S. Cl. CPC B62D 17/00
USPC 280/86.751; 280/86.758

(57) ABSTRACT

The invention relates to an apparatus for adjusting camber and/or toe of a vehicle wheel having a wheel carrier (10) on which the wheel is rotatably mounted, the wheel guide element (10) having a carrier member (12) receiving the wheel, a guide member (14) on the axle side and at least one intermediately arranged actuating element (16, 18) for adjusting camber and/or toe of the vehicle wheel, which actuating element (16, 18) has a drive connection to at least one servomotor (26, 28). According to the invention, the carrier member (12) and the guide member (14) are each coupled by a cardanic articulated connection to a corresponding articulated fork (32, 34) and a supporting ring (40) connecting the articulated fork (32, 34) via bearing pins (38), and the servomotor (26, 28) is connected to the actuating element (16, 18) via a belt drive (30) which passes through an intermediate space (39) in the articulated forks (32, 34).

The invention relates to a device for adjusting camber and/or toe of the wheels of wheel suspensions, in particular for motor vehicles, according to the preamble of claim 1.

A generic device is described in DE 10 2008 011 367 A1, wherein the camber and/or toe of the wheels is adjustable while driving by way of built-in wheel actuating cylinders integrated in the wheel carrier. The wheel carrier is hereby divided into a carrier member receiving the wheel and a guide member articulated on wheel suspension elements, which pivot the carrier member relative to the guide member by rotating one or both actuating cylinders with electric motors and with adjusting drives formed by spur gears. The adjustment is hereby effected in that the rotationally symmetrical actuating cylinders have a common rotation axis and surfaces or rotary bearings inclined relative to the rotation axis, which when the actuating cylinders are rotated in the same direction or in opposite directions enable a corresponding pivoting motion of the carrier member by camber and/or toe angles of up to 5°.

It is an object of the invention to modify the device of the generic type so as to enable a simple, backlash-free adjustment of camber and/or toe of wheels in a compact arrangement.

This object is attained according to the invention with the features of claim 1. Advantageous embodiments of the invention are recited in the dependent claims.

According to the characterizing part of claim 1, the carrier member and the guide member are each coupled by a cardanic articulated connection with a respective articulated fork and a supporting ring connecting the articulated forks via bearing pins. The articulated connection forms a rotation-lock between the guide member and the carrier member, enabling transmission of torques, such as braking torques, to the vehicle. According to the invention, the servomotor is connected with the adjusting element by a belt drive. The belt drive passes through an intermediate space between the articulated forks.

According to the invention, the servomotor is here arranged radially outside of the cardanic articulated connection. The servomotor is connected with the actuating element arranged inside the cardanic articulated connection by the belt drive to provide a drive connection with the actuating element. The belt drive is particularly advantageous compared to a gear drive, because due to space limitations, the drive gear of the servomotor in such a gear drive must be connected with a ring gear of the actuating element by an additional intermediate gear. The intermediate gear is required to bridge the gap between the articulated forks, since the size of the ring gear on the actuating element is limited by the unobstructed width of the cardanic forks and cannot be radially expanded so far as to enable a direct engagement without an additional intermediate gear. The belt drive used in the invention is also advantageous for reducing the number of parts and for providing greater dynamics, since the rotational mass of the otherwise required intermediate gear need not be accelerated. Additional advantages of belt drive are the quieter operation, ease of installation as well as reduction in weight.

According to one embodiment, the actuating element includes two rotary parts which can rotate with respect to each other and cooperate via inclined surfaces. By rotating one or both rotary parts with servomotors, the carrier member and thus the wheel of the vehicle can be adjusted over predetermined toe and/or camber angles. Preferably, each of these rotary parts may have a dedicated servomotor. The belt drives may extend through intermediate spaces of the articulated forks which are offset from one another in the circumferential direction, providing an overall compact arrangement. The servomotors of the rotary parts may also be arranged with a mutual offset in the circumferential direction.

The belt drive may be formed with a gear on the actuating element, a drive gear on the servomotor and traction means drivingly connecting the two gears. The traction means, for example a chain, allow additional degrees of freedom both in the structural design of the transmission ratio of the belt drive, as well as in the arrangement of the electric motors actuating the actuating cylinders by taking into account the other structures and wheel suspension parts in the region of the wheel carrier.

In a particular preferred embodiment, the gears may be toothed gear wheels and the traction means may be a toothed belt. This approach has the particular advantage that the toothed belt drive does not require any lubricants and the rotary parts can be adjusted without producing noise. A suitable pretension of the toothed belt also ensures transmission of the actuating movements between the electric motors and the corresponding rotary parts without play.

Furthermore, one or both toothed gear wheels may be provided with lateral guide flanges to increase the safety of the drive.

The cardanic articulated connection serves as a rotation-lock and a torque support between the carrier member and the guide member. Lastly, friction brakes or rotation-locks which are effective in the unactivated state may be provided in the servomotors for preventing unintentional, automatic adjustment of the rotary parts that determine the toe and camber of the wheel caused by static or dynamic wheel loads.

An embodiment of the invention will now be explained in more detail. The schematic drawing shows in:

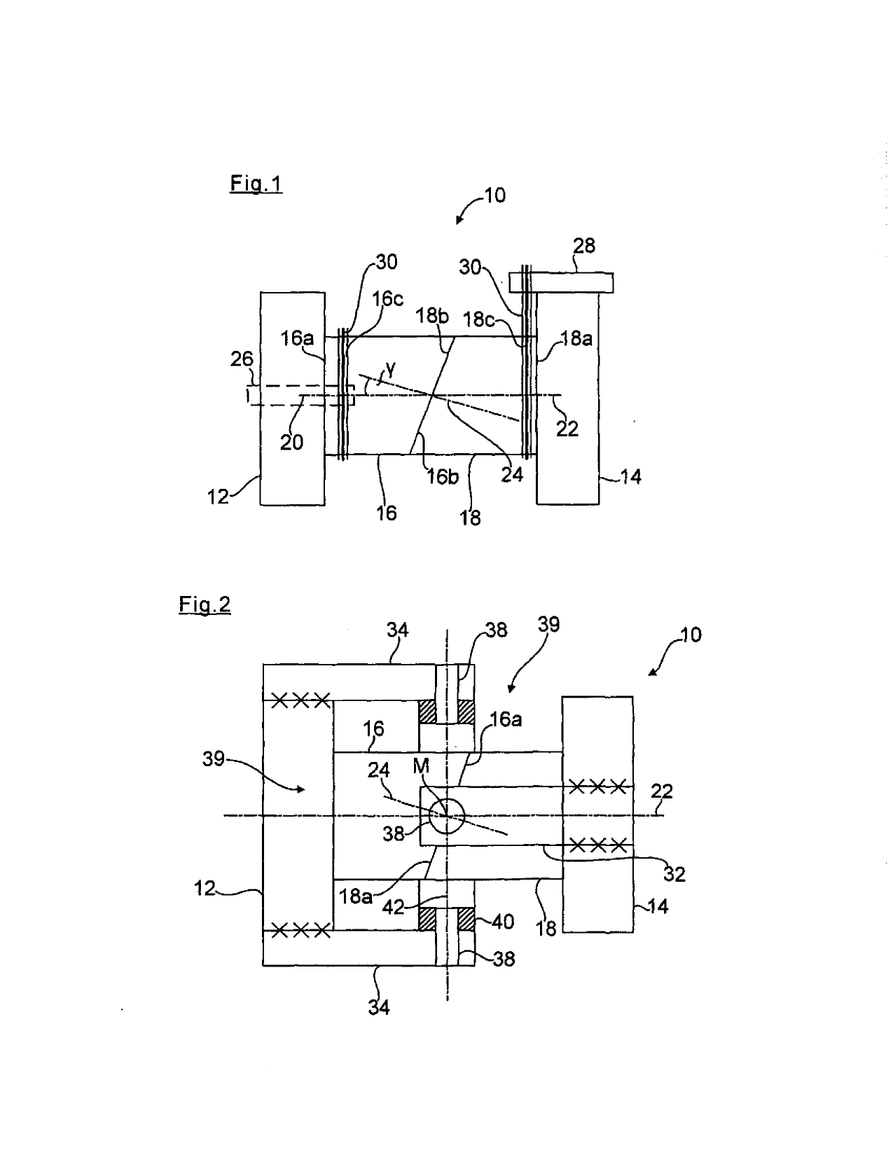

FIG. 1 a schematic diagram of the apparatus for adjusting toe and camber angle of a wheel suspension for motor vehicles having a multi-part wheel carrier;

FIG. 2 the device of FIG. 1, illustrating the cardanic connection between the guide member and the carrier member of the wheel carrier;

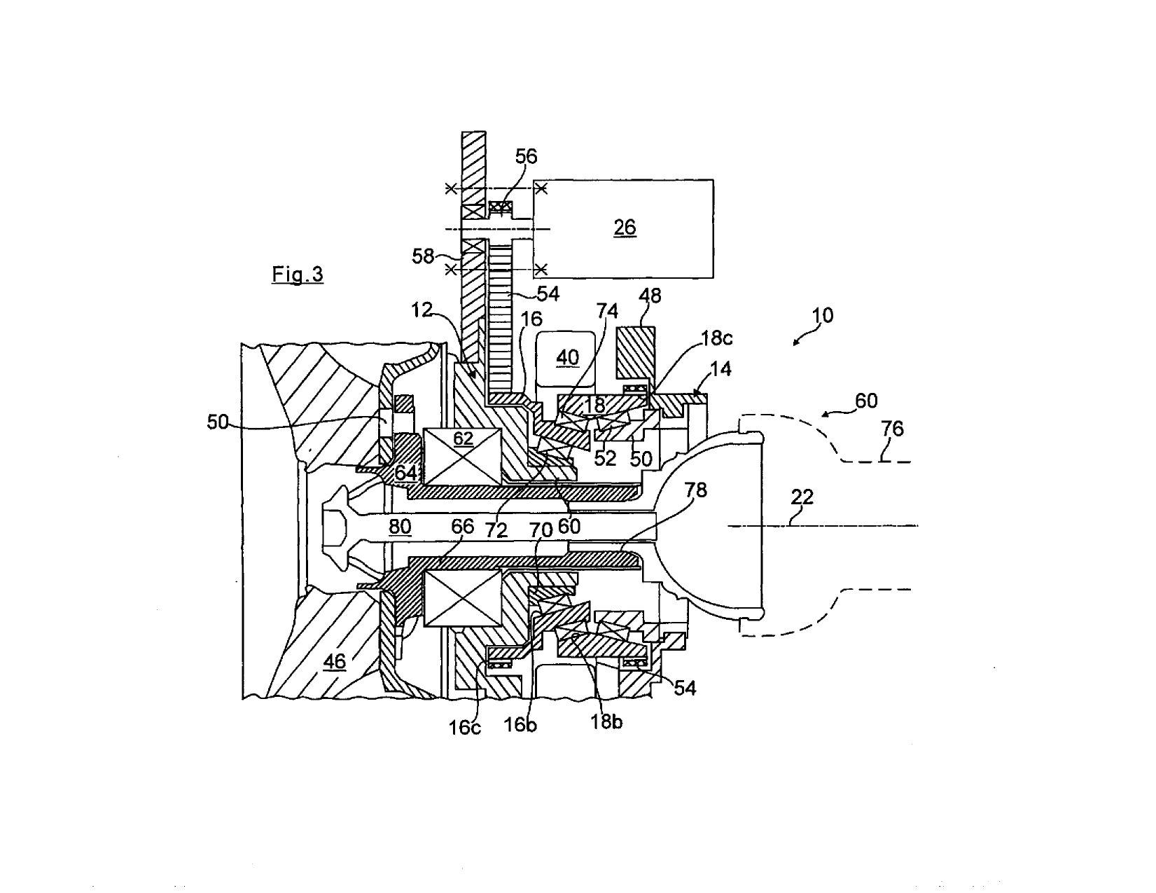

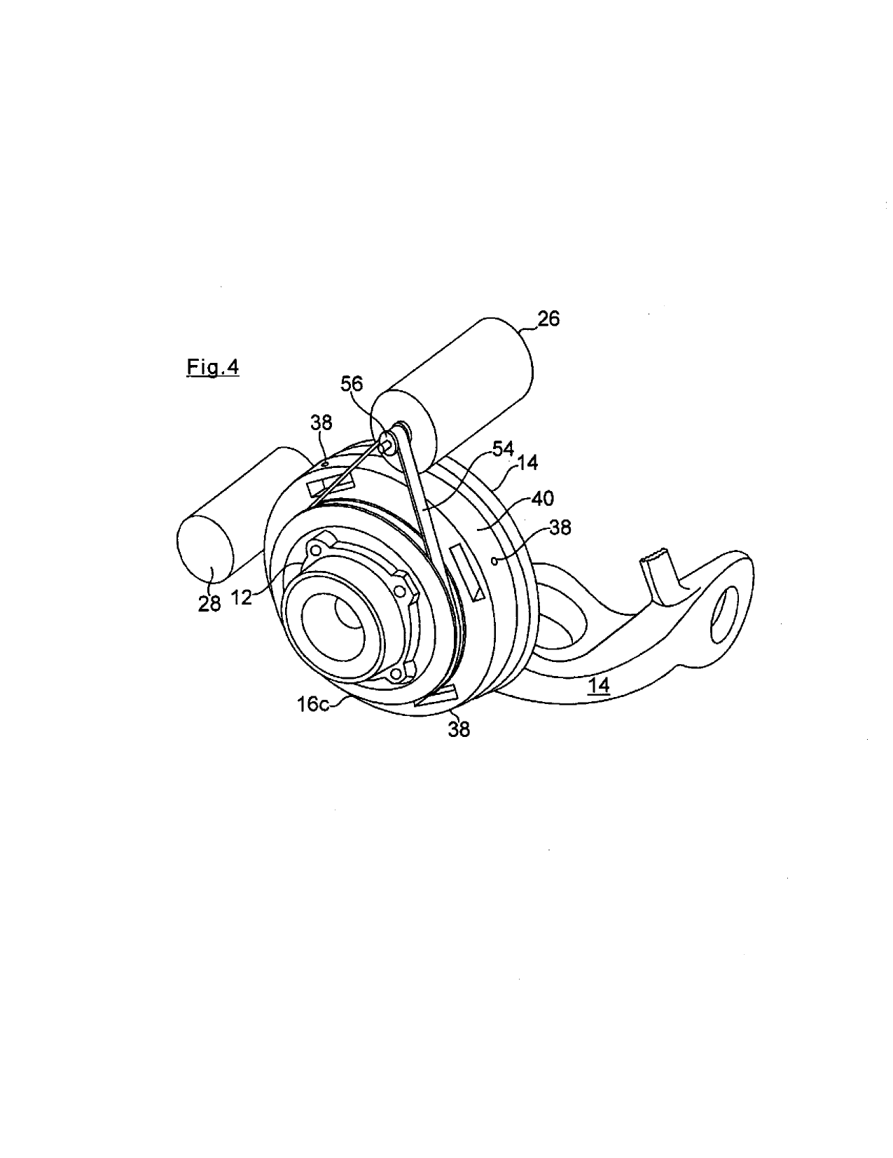

FIG. 3 an embodiment of the apparatus of FIGS. 1 and 2, with a carrier member supporting a wheel, with a guide member articulated on wheel guiding elements of the wheel suspension, and with two rotatable rotary parts which are adjustable via electric motors and toothed belt drives, and

FIG. 4 the apparatus according to FIG. 3 in a three-dimensional representation of a toothed belt drive operating on the rotary parts.

For an explanation of the principle of the invention, FIG. 1 shows in form of a schematic block diagram a wheel guide element or wheel carrier 10 of a wheel suspension for motor vehicles, which for an adjustment of the camber and/or toe of the wheel in the region of the wheel bearings is subdivided as follows:

The wheel carrier 10 has a carrier member 12, in which the wheel and the brake member (brake disk or brake drum) of a service brake of the motor vehicle is rotatably supported. It should be noted that, unless otherwise mentioned, the functional parts of the suspension are of conventional design.

Furthermore, the wheel carrier 10 has a guide member 14 which cooperates with the wheel suspension or optionally forms a part of the wheel suspension.

Two substantially rotationally symmetrical rotary parts 16, 18, which are each rotatably connected with the carrier member 12 and the guide member 14 via respective rotation axes 20, 22, are arranged between the carrier member 12 and the guide member 14 as actuating elements. The two rotation axes 20, 22 in FIG. 1 are coaxially aligned.

Whereas the contact surfaces 16a, 18a of the rotary parts 16, 18 directly adjacent to the carrier member 12 and the guide member 14 are constructed with rotational symmetry, the rotary parts 16, 18 abut each other by way of planar or conically inclined surfaces 16b, 18b and are rotatably connected to each other via rotation axes 24. As can be seen, the rotation axes 24 are hereby perpendicular to the inclined surfaces 16b, 18b and are inclined at a defined angle γ with respect to the rotation axes 20, 22.

A respective electric servomotor 26, 28 is arranged on the carrier member 12 and on the guide member 14 in an arrangement to be described later, which are drivingly connected to the rotary parts 16, 18 via toothed belt drives 30. The rotary parts 16, 18 can be rotated with the servomotors 26, 28 in both rotation directions, either in the same direction or in opposite directions, whereby the carrier member 12 changes the toe angle and/or the camber angle of the wheel by executing a pivoting or tumbling motion relative to the guide member 14.

FIG. 2 shows schematically a cardanic coupling between the guide member 14 and the carrier member 12 which operates, inter alia, as rotation-lock and torque support, for example, for braking torques and drive torques acting on the carrier member 12.

For this purpose, articulated forks 32, 34, which are offset with respect to each other by 90° and which are connected with each via bearing pins, commonly designated with 38, and a supporting ring 40, are attached to the guide member 14 and the carrier member 12. The carrier member 12 can thus be cardanically pivoted about a vertical axis 42 and about an axis perpendicular to the drawing plane, wherein the instantaneous center M of the cardanic connection, as can be seen, intersects the rotation axis 22 and the inclined rotation axis 24 of the rotary parts 16, 18.

FIG. 3 shows the structure of the wheel carrier 10 in a partial longitudinal section taken along the rotation axis 22 of the wheel of the wheel suspension, wherein the description is limited to the essential components of the invention. Functionally identical parts are denoted by identical reference symbols.

As described above, the wheel carrier 10 is composed of the guide member 14 which is connected for articulation relative to wheel guiding elements of the wheel suspension, such as control arms, etc., the carrier member 12 supporting the wheel (rim 46) and the rotary parts 16, 18.

The guide member 14 has a supporting flange 48 which supports a radially inner bearing ring 50. The bearing ring 50 forms via bearing rollers 52 in conjunction with the radially outer rotary part 18 a first roller bearing, whose rotation axis coincides with the rotation axis 22.

The rotary part 18 is provided at its outer periphery with a toothed belt wheel 18c which drivingly cooperates via a toothed belt 54 with a driving toothed belt wheel 56 of the electric motor 28, which is not visible in FIG. 3. The electric motor 28 is also attached on the support plate 48 of the guide member 14.

The carrier member 12 has a radially oriented flange portion 58 and an axially extending hub section 60. The hub section 60 extends radially inside the two rotary parts 16, 18 toward the bearing ring 50 of the support plate 48

A double-row wheel bearing 62 is arranged inside the flange portion 58 as a rotary bearing for a wheel flange 64 having a hub section 66 which protrudes axially into the hub section 60 as far as to about the bearing ring 50.

The wheel or the rim 46 and the brake disk of a disk brake are attached on the wheel flange 64 with wheel bolts (not shown). The caliper of the disk brake is attached in an unillustrated manner to the flange portion 58 of the carrier member 12.

Furthermore, the rotary part 16 is rotatably supported on the hub section 60 of the carrier member 12 via an inner bearing ring 70 and bearing rollers 72, wherein the rotation axis 24 (shown only in FIG. 1) of the rotary part 16 is inclined relative to the wheel rotation axis 22.

Moreover, the rotary member 16 is rotatably supported in the rotary part 18 via a third roller bearing with bearing rollers 74. The relevant inclined surfaces 16b, 18b and the cone angle of the rotary parts 16, 18 are here implemented differently and inclined with respect to the rotation axis 22, so that as a result of their rotation, the carrier member 12 can be adjusted relative to the guide member 14 and the camber angle and/or the toe angle of the wheel of the wheel suspension can be adjusted in a range of about 5° from a neutral position.

The rotary part 16 has also an integrally formed toothed belt wheel 16c and is adjusted via an additional toothed belt 54 and a toothed belt wheel 56 of the electric motor 26. The electric motor 26 is attached to the flange portion 58 of the carrier member 12.

FIG. 4 shows, as a representative example for both toothed belt drives 30, the toothed belt drive 30 for adjustment of the carrier member 12 via the rotary part 16, wherein it is evident that the toothed belt 54 wraps around the relatively small toothed belt wheel 56 on the drive shaft of the electric motor 26 and the relatively large toothed belt wheel 16c. The toothed belt drive 30 for adjusting the rotary part 18 is constructed as a mirror image.

Axial guide flanges (without a reference symbol) for guiding the toothed belt are provided on both sides of the toothed belt wheels 16c and 56.

The electric motors 26, 28 are arranged with a mutual circumferential offset of about 90°, allowing the corresponding toothed belts 54 of the toothed belt drives 30 to each extend between the articulated forks 32, 34 of the guide member 14 and the carrier member 12 (compare in FIG. 4 the indicated bearing bolts 38 of the supporting ring 40, which determine the unillustrated position of the articulated forks 32, 34).

The electric motors 26, 28 are provided in a conventional manner with interlocking or frictional brake devices which are effective when the electric motors 26, 28 are not activated, thereby reliably preventing accidental displacement of the rotary parts 16, 18.

The driving toothed belt wheels 56 may be cantilevered on the drive shafts of the electric motors 26, 28, or as illustrated in FIG. 3 in relation to the electric motor 26, additionally supported in the respective supporting flange 58, 48.

When the wheel of the wheel suspension is driven via a drive shaft 76, the drive shaft 76 may be drivingly connected with the wheel flange 64, as illustrated in FIG. 3, via a spline 78 in the hub section 66 and with a clamping screw 80.

Chain drives 30 with suitably designed sprockets and a chain as revolving medium may be employed instead of the described toothed belt drives.

### REFERENCE SYMBOLS

10 wheel carrier
12 carrier member
14 guide member
16, 18 rotary parts
16a, 18a contact surfaces
16b, 18b inclined surfaces
16c, 18c toothed belt wheels
20, 22, 24 rotation axes
26, 28 servomotors
30 toothed belt drives
32, 34 articulated forks
38 bearing bolt
40 supporting ring
42 axis
46 rim
48 supporting flange
50 bearing ring
52 bearing rollers
56 toothed belt wheel
58 flange section
60 hub section
62 wheel bearings
64 wheel flange
66 hub section
70 inner bearing ring
72 bearing rollers
74 bearing rollers

What is claimed is:

1.-9. (canceled)

10. An apparatus for adjusting camber and/or toe of a vehicle wheel, comprising:
a wheel carrier on which the vehicle wheel is rotatably mounted, wherein the wheel carrier comprises
a carrier member receiving the vehicle wheel,
an axle-side guide member,
at least one actuating element disposed between the carrier member and the guide member for adjusting camber and/or toe of the vehicle wheel,
at least one servomotor drivingly connected with the at least one actuating element,
a first articulated fork coupled to the carrier member by a first cardanic articulated connection,
a second articulated fork coupled to the guide member by a second cardanic articulated connection,
a supporting ring connecting the first and second articulated forks via bearing pins, and
a belt drive extending through an intermediate space of the articulated forks connecting a servomotor with a corresponding actuating element.

11. The apparatus of claim 10, wherein the belt drive comprises a gear disposed on the at least one actuating element, a drive gear disposed on the at least one servomotor, and a traction means connecting the gear with the drive gear.

12. The apparatus of claim 11, wherein the traction means comprises a toothed belt or a chain.

13. The apparatus of claim 12, wherein when the traction means comprises a toothed belt, the gear and the drive gear are constructed as toothed belt wheels, and when the traction means comprises a chain, the gear and the drive gear are constructed as sprockets.

14. The apparatus of claim 13, wherein at least one of the toothed belt wheels the toothed belt drive comprises lateral guide flanges.

15. The apparatus of claim 10, wherein the at least one actuating element is formed of two rotary parts constructed to rotate with respect to one another and to cooperate via inclined surfaces.

16. The apparatus of claim 15, wherein a servomotor is assigned to each of the two rotary parts in one-to-one correspondence.

17. The apparatus of claim 16, wherein the belt drives connecting the two servomotors with the corresponding rotary parts extend through circumferentially arranged, mutually offset intermediate spaces of the articulated forks.

18. The apparatus of claim 17, wherein the servomotors of the two rotary parts are arranged with a mutual circumferential offset.

19. The apparatus of claim 18, wherein both rotary parts comprise belt drives, and wherein each of the traction means of the servomotors having a mutual circumferential offset extend through adjacent intermediate spaces of the first and second articulated forks.

20. The apparatus of claim 10, wherein the at least one servomotor comprises a friction brake or a rotation lock which are effective in an unactivated state of the at least one servomotor.
